(19) United States
(12) Patent Application Publication
(10) Pub. No.: US 2010/0017507 A1
(43) Pub. Date: Jan. 21, 2010

(54) METHOD AND APPARATUS OF COMBINING MULTIPLE PACKETS INTO PROTOCOL TRANSACTIONS WITH REQUEST AND RESPONSE DETAIL FOR ENHANCED TROUBLESHOOTING IN A LINE RATE NETWORK MONITORING DEVICE

(75) Inventors: Bruce Kosbab, Colorado Springs, CO (US); Dan Prescott, Colorado Springs, CO (US)

Correspondence Address: PATENTTM.US, P. O. BOX 82788, PORTLAND, OR, 97282-0788, US

(73) Assignee: FLUKE CORPORATION, Everett, WA (US)

(21) Appl. No.: 12/242,455

(22) Filed: Sep. 30, 2008

Related U.S. Application Data
(60) Provisional application No. 61/080,686, filed on Jul. 15, 2008.

(51) Int. Cl. G06F 15/173

(52) U.S. Cl. 709/224

(57) ABSTRACT

Multiple packets are combined into protocol transactions with request and response detail for enhanced troubleshooting in a network monitoring device. The analysis may be done at a line rate, in an always on operation mode, providing constant gathering of analysis data and information.

### CROSS-REFERENCE TO RELATED APPLICATIONS

This application claims priority of U.S. provisional patent application 61/080,686, filed Jul. 15, 2008, entitled METHOD AND APPARATUS OF COMBINING MULTIPLE PACKETS INTO PROTOCOL TRANSACTIONS WITH REQUEST AND RESPONSE DETAIL FOR ENHANCED TROUBLESHOOTING IN A LINE RATE NETWORK MONITORING DEVICE.

### BACKGROUND OF THE INVENTION

This invention relates to networking, and more particularly to method and apparatus of the monitoring and analysis of network traffic.

In a computer networking environment, for monitoring and/or troubleshooting of network operation, network traffic packets may be captured and stored for post-processing analysis later, in order to derive details to identify and solve certain network problems.

Such systems can raise issues, however, since the volume of data that might be stored can be large in high speed, high traffic volume networks. And, the post-processing aspect of the analysis takes the analysis out of a real-time mode of operation.

These issues can result in an increased requirement for storage and processing capability in a network test environment.

### SUMMARY OF THE INVENTION

In accordance with the invention, deep packet inspection is performed on the network, transport, and application layers of a packet and detailed transaction information and metrics are determined and stored for later retrieval.

In accordance with the invention, improved measurement and analysis of network traffic is enabled.

Accordingly, it is an object of the present invention to provide an improved system and method of network analysis.

It is a further object of the present invention to provide an improved network monitoring device for enabling enhanced troubleshooting.

It is yet another object of the present invention to provide improved methods of network monitoring and analysis.

Another object of the invention is to provide an improved method and apparatus for performing analysis of network traffic as it is observed.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a block diagram of a network with a network analysis product interfaced therewith;

FIG. 2 is a block diagram of a monitor device for combining multiple packets into protocol transactions with request and response detail for enhanced troubleshooting; and

FIG. 3 is a diagram of network monitoring in accordance with the invention.

### DETAILED DESCRIPTION

The system according to a preferred embodiment of the present invention comprises a method and apparatus for combining multiple packets into protocol transactions with request and response detail for enhanced troubleshooting in a line rate network monitoring device.

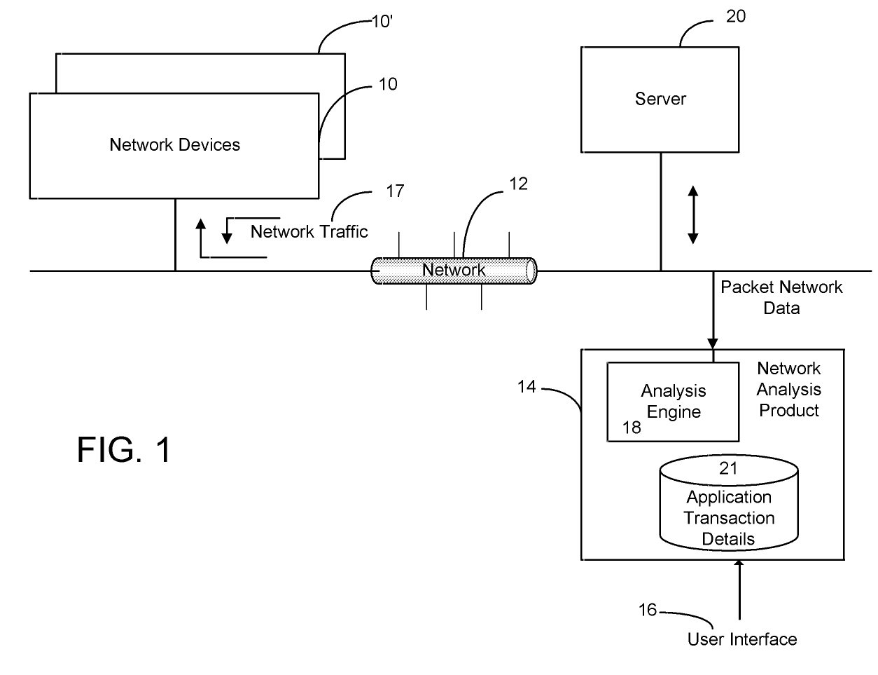

Referring to FIG. 1, a block diagram of a network with an apparatus in accordance with the disclosure herein, a network may comprise plural network devices 10, 10′, etc., which communicate over a network 12 by sending and receiving network traffic 17. The traffic may be sent in packet form, with varying protocols and formatting thereof.

A network analysis product 14 is also connected to the network, and may include a user interface 16 that enables a user to interact with the network analysis product to operate the analysis product and obtain data therefrom, whether at the location of installation or remotely from the physical location of the analysis product network attachment.

The network analysis product comprises hardware and software, CPU, memory, interfaces and the like to operate to connect to and monitor traffic on the network, as well as performing various testing and measurement operations, transmitting and receiving data and the like. When remote, the network analysis product typically is operated by running on a computer or workstation interfaced with the network.

The analysis product comprises an analysis engine 18 which receives the packet network data and interfaces with application transaction details data store 21.

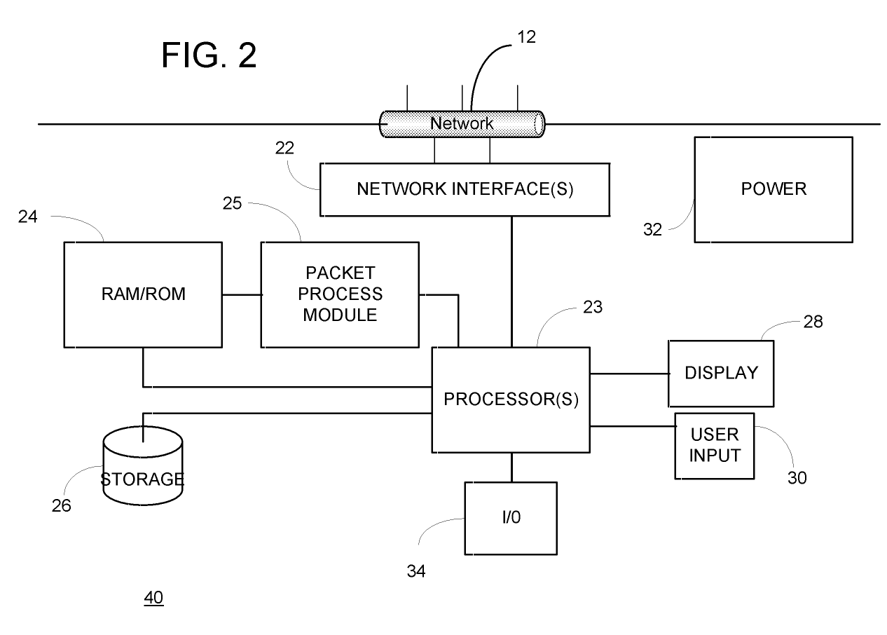

FIG. 2 is a block diagram of a test instrument/analyzer 40 via which the invention can be implemented, wherein the instrument may include network interfaces 22 which attach the device to a network 12 via multiple ports, one or more processors 23 for operating the instrument, memory such as RAM/ROM 24 or persistent storage 26, display 28, user input devices 30 (such as, for example, keyboard, mouse or other pointing devices, touch screen, etc.), power supply 32 which may include battery or AC power supplies, other interface 34 which attaches the device to a network or other external devices (storage, other computer, etc.). Packet processing module 25 provides processing of packets and storage of data related thereto for use in the analysis product to assist in the combining multiple packets into protocol transactions with request and response detail for enhanced troubleshooting, as discussed further herein.

In operation, the network test instrument is attached to the network, and observes transmissions on the network to collect information.

The packet process module 25 may suitably implement the analysis engine, whereby packet layer or application layer details.

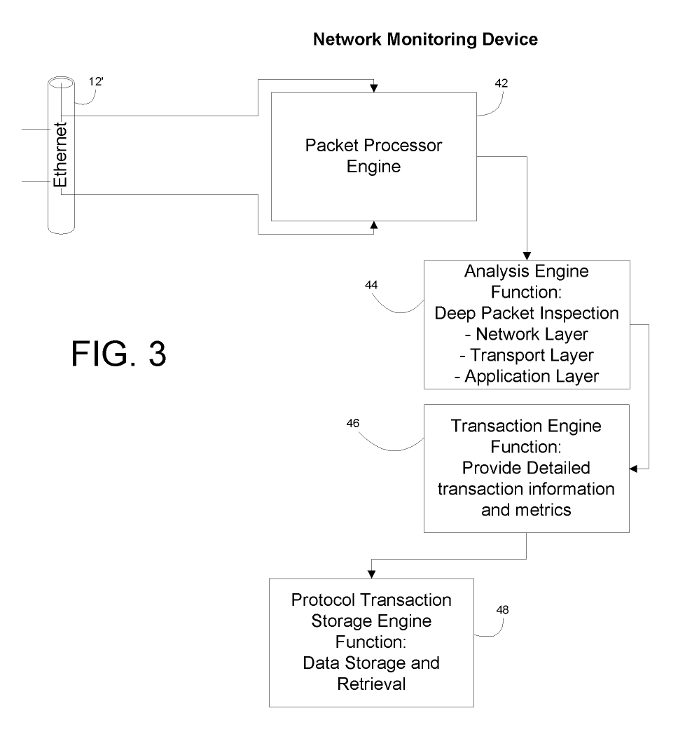

FIG. 3 is a diagram of network monitoring in accordance with the invention. The network 12′, which is an Ethernet in the illustrated embodiment, interfaces to packet processor engine 42, which comprises an analysis engine function 44. Analysis engine 44 functions to perform deep packet inspection of the network, transport, and application layers of a packet, supplying data to the transaction engine 46. Transaction engine 46 functions to provide detailed transaction information and metrics, the output of the transaction engine being provided to protocol transaction storage engine 48, which provides the function of data storage and retrieval.

The transaction engine analyzes network traffic to identify and record application transactions. A transaction consists of a client request and the corresponding server response. Both the request and the response may be sent over the network in multiple packets. This is especially typical for the response portion of a transaction, although a request may consist of multiple packets as well.

One example of an application transaction is the request and subsequent response that a web browser makes to a web server and the web page that is returned by the web server. Because the web page returned by the server usually contains several Kbytes of data, the transaction response usually is sent in multiple packets.

The transaction engine monitors the network traffic, identifies client and server conversations, and then reassembles the request and response packets between each client and server in order to analyze the transaction. The transaction engine measures and records several usage and performance metrics for each transaction. Usage metrics include, among others, the number of bytes and the number of packets in the request and the response portions of the transaction. Performance metrics include the application response time which is the elapsed time required by the application server to process the request and issue a response. The transaction engine also records the request and response data from the transaction. An example of this information is the requested URL in a web transaction and the corresponding web page returned by the server.

Because applications use a variety of protocols and interact in a variety of ways, the transaction engine performs application-specific analysis. The transaction engine has application-specific analysis modules that perform analysis that is appropriate for the application being analyzed. For example, a web application is analyzed by the HTTP analyzer, and an Oracle database application is analyzed by the Oracle database analyzer.

This information which is determined by the transaction engine is saved for later use in troubleshooting.

In accordance with the invention, a network monitoring device operates in an “always on” mode, observing network traffic and performing analysis as the data is observed. The specific packets are not themselves stored, but instead, protocol dependent application transactions are stored which can allow a user to view specifics of problems, without having to wade through packet capture data, which can typically be voluminous.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A method of monitoring network traffic, comprising:
providing an analysis engine for performing deep packet inspection of network traffic;
providing a transaction engine for determining detailed transaction information and metrics from said deep packet inspection; and
providing a protocol transaction storage engine for performing data storage and retrieval.

2. The method according to claim 1, wherein said analysis engine performs deep packet inspection of network layer, transport layer and application layer network traffic.

3. The method according to claim 1, wherein said determining detailed transaction information and metrics comprises recording usage and performance metrics for a transaction.

4. The method according to claim 3, wherein said usage metrics for a transaction comprise the number of bytes in a request and a response portion of the transaction.

5. The method according to claim 3, wherein said usage metrics for a transaction comprise the number of packets in a request and a response portion of the transaction.

6. The method according to claim 3, wherein said performance metrics comprise an application response time.

7. The method according to claim 3, wherein said determining detailed transaction comprises recording a request and a response data from the transaction.

8. A network traffic monitoring apparatus, comprising:
an analysis engine for performing deep packet inspection of network traffic;
a transaction engine for determining detailed transaction information and metrics from said deep packet inspection; and
a protocol transaction storage engine for performing data storage and retrieval.

9. The network traffic monitoring apparatus according to claim 8, wherein said analysis engine performs deep packet inspection of network layer, transport layer and application layer network traffic.

10. The network traffic monitoring apparatus according to claim 8, wherein said determining detailed transaction information and metrics comprises recording usage and performance metrics for a transaction.

11. The network traffic monitoring apparatus according to claim 10, wherein said usage metrics for a transaction comprise the number of bytes in a request and a response portion of the transaction.

12. The network traffic monitoring apparatus according to claim 10, wherein said usage metrics for a transaction comprise the number of packets in a request and a response portion of the transaction.

13. The network traffic monitoring apparatus according to claim 10, wherein said performance metrics comprise an application response time.

14. The network traffic monitoring apparatus according to claim 3, wherein said determining detailed transaction comprises recording a request and a response data from the transaction.
